(19) United States
(12) Patent Application Publication
(10) Pub. No.: US 2023/0004551 A1
(43) Pub. Date: Jan. 5, 2023

(54) METHOD OF PROCESSING AND STORING DATA FOR REAL TIME ANOMALY DETECTION PROBLEM

(71) Applicant: VIETTEL GROUP, Ha Noi City (VN)

(72) Inventors: Dang Sao Cao, Dien Chau District (VN); Van Thuyet Tran, Kien Xuong District (VN); Duc Hieu Nguyen, Hung Ha District (VN); Dinh Tam Nguyen, Vinh City (VN)

(73) Assignee: VIETTEL GROUP, Ha Noi City (VN)

(21) Appl. No.: 17/568,173

(22) Filed: Jan. 4, 2022

(30) Foreign Application Priority Data
Jul. 2, 2021 (VN) 1-2021-04085

(51) Int. Cl. G06F 16/23; G06F 17/18

(52) U.S. Cl. CPC G06F 16/2365; G06F 17/18

(57) ABSTRACT

The method of processing and storing data for real time anomaly detection including steps: step 1: building a historical database over time, mean and standard deviation database; step 2: make a selection number of blocks and number of points in one block, divide historical data into equal-sized blocks and build formulas to calculate average, standard deviation of each data block and the whole data; Step 3: create a data mapping process that runs independently to read collected data, normalize data and interact with the in-memory database to write data history over time; step 4: perform data anomaly detection of new incoming data with mean, standard deviation of historical data already stored in database on read-only memory (RAM).

### FIELD OF THE INVENTION

The invention relates to the method of processing and storing data for real time anomaly detection problem. The method proposed in the present invention is used on the basis of anomaly detection technology and is applied in the field of real time computing.

### TECHNICAL STATUS OF THE INVENTION

Typically, the data processing and storing method for real time anomaly detection is represented by the following simplified steps:

Step 1: incoming data will be stored in the database.

Step 2: perform a comparison of the incoming data with past data points to conclude whether the incoming data is anomalous or not and then issue warnings.

However, as the number of historical data points to be used for comparison increases, three problems arise:

One is that the computer needs to store a large amount of historical data on random access memory or read-only memory (RAM) while the amount of RAM is limited.

The second is that the requirement to retrieve historical data from the database is continuously costly and leads to database failure in the long run.

The third is the increased computation time, while for the real time anomaly detection problem (the problem of time constraints from the occurrence of an event until the system responds to that event), the computation time of basic operations needs to reach a certain speed or time limit.

The method of processing and storing data for real time anomaly detection problem solves the above three problems well. Respond to real time anomalous data detection and provide treatment for similar problems that can be applied to speed up computation.

### THE TECHNICAL NATURE OF THE INVENTION

The purpose of the present invention is to provide a method of processing and storing data for real time anomaly detection problem. This method increases computing power many times over (depending on how data storage and computation are divided on RAM read-only memory).

To achieve the foregoing, the present invention provides a method of processing and storing data for real time anomaly detection problem with the following specific implementation steps:

Step 1: build a historical database over time, a database of mean and standard deviation. More specifically: the data after coming to the system will be saved to the database according to the timestamp, after the specified time periods, the data will be averaged and saved to the database.

Step 2: make a selection number of blocks and number of points in one block, divide the historical data into blocks of equal size and build a formula to calculate the mean, the standard deviation of each data block and the mean, the median standard deviation of the whole data:

In fact, the detection of data anomalies using different algorithms requires different data processing and storage. For algorithms that require the use of the mean and the median standard deviation of historical data to make an outlier assessment, the following steps apply:

Step 2.1: divide historical data into equal blocks, namely: suppose historical data to be averaged, standard deviation is n×m data points, we divide into m data blocks, each block contain n points data.

Step 2.2: determine the number of historical data points to use.

Step 2.3: construct formulas to calculate the mean, the standard deviation of data blocks and the mean, the median standard deviation of the whole data.

Step 3: create an independently running data mapping process that reads collected data, normalizes the data, and interacts with the in-memory database to write historical data according to time.

Step 4: process the calculation of the mean, the standard deviation of the data blocks and the mean, the median standard deviation of the whole data and store it in the database on read-only memory (RAM).

To perform anomaly detection according to the data division in step 2. We use two independent processes: the process of calculating the mean, the standard deviation, and performing the calculation when n points have been collected data for that block and for all historical data is shown in step 4.1; anomalous data detection real time process reads the data in real time and checks whether the data point is anomalous performed in step 4.2.

Step 4.1: process the calculation of the mean, the standard deviation of the data blocks and the mean, the median standard deviation the whole data and save it in the database with the data structure as Table 2, and are stored directly on RAM:

The process of calculating the mean, standard deviation is scheduled to execute after n×t time because the data is written to the database in t time period, so after n×t time we proceed with the following next steps.

Step 4.1.1: read the historical data of the last n points in the database stored in Step 3.

Step 4.1.2: calculate the mean and standard deviation of the n points obtained.

Step 4.1.3: calculate the mean, the median standard deviation of all historical data stored in the database: based on the mean, the standard deviation of up to m−1 previously calculated data blocks and the mean, the standard deviation of the nearest n points using the formulas established in Step 2.3.

Step 4.1.4: store the last n-point mean, the nearest n-point standard deviation, the mean of all historical data, and the median standard deviation of all historical data into a datastructured database Table 2 to query.

Step 4.2: anomaly real time process reads real time data from the database and performs anomaly detection.

Then, because in Step 4.1, the mean, the median standard deviation of historical data has been calculated, it is not necessary to recalculate them each time the incoming data is available. It will to speed up anomaly detection computation and real time response to the problem.

This solution helps to solve the problem of real time calculation of both anomalous data detection, avoiding hard drive scanning and database file opening and closing many times.

### BRIEF DESCRIPTION OF THE DRAWINGS

In order to describe the invention in a more coherent, clear and understandable manner, the figures below depict parts of the invention:

FIG. 1: Describe the data flow processed in the real time anomaly detection system.

FIG. 2: Describe the processing flow that maps data from the source to the database.

FIG. 3: Describes the division of historical data into smaller blocks to handle averaging over each block and over the data as a whole.

FIG. 4: Describe the real time progress of detecting anomalous data at a specific time.

FIG. 5: Describe the real time data processing flow of the anomaly detection system using the data averaging algorithm.

### DETAILED DESCRIPTION

In the Anomaly Detection System, it is the detection of abnormal data occurring in the system, the requirement is that the anomaly should be detected as soon as possible to minimize the risk of impact to the system or in other words real time detection.

The method of processing and storing data for real time anomaly detection problem proposed in the present invention consists of sequential implementation steps detailed below:

Step 1: build a historical database over time, a database of mean and standard deviation.

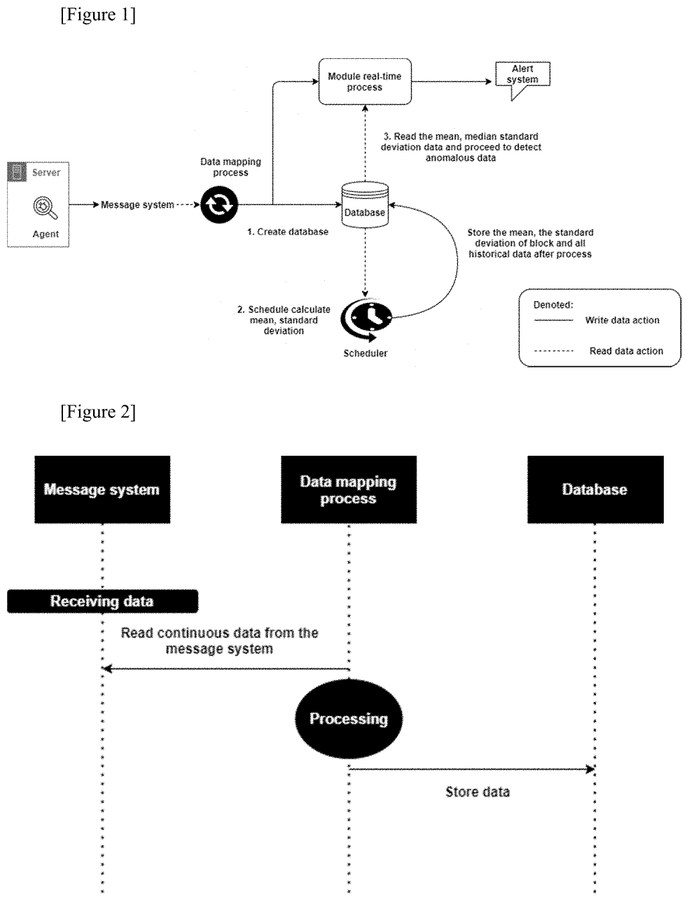

Refer to FIG. 1, which describes the flow of data processed in a real time anomaly detection system, and FIG. 2, which describes the processing flow that maps data from the source to the database.

System data is collected by agents installed on the server including information such as percentage of central processor usage, percentage of internal memory used, network latency, etc. that will be stored on a centralized messaging system to task different systems using the same data source. Thanks to an independently running Process Mapping Data, it reads data from the centralized messaging system, normalizes the data, and interacts with the on-memory database management system (in-memory database) to write data over time.

The content of the data includes: the time the data was written, the source of the data to be written, the value of the data to be written.

When a record is sent to the messaging system, the Data Mapping Process writes the data to the database with the following structure:

TABLE 1
Historical data table over time.

| Field name | Datatype | Meaning |
|---|---|---|
| Id | Integer | Table primary key, integer |
| | | data type, unique identifier |
| | | of the data |
| Timestamp | Milliseconds | The time the data was |
| | | written, has the time data |
| | | type |
| Source | String | Data information to be |
| | | written, has a string data |
| | | type |
| Value | Real | Received data value, |
| | | has real numeric data type |

In addition, it is necessary to build a database storage structure for the mean and standard deviation values of historical data points as follows:

TABLE 2
Table of mean and standard deviation.

| Field name | Datatype | Meaning |
|---|---|---|
| Id | Integer | Table primary key, |
| | | integer data type, unique |
| | | identifier |
| Timestamp | Milliseconds | Historical mean data |
| | | logging time, with time |
| | | data type |
| Mean | Real | Mean of all necessary |
| | | historical data, with real |
| | | number data type |
| Median_standard_deviation | Real | Median of block standard |
| | | deviations of all |
| | | historical data, with data |
| | | type real |
| Nearest_block_mean | Real | Last received data |
| | | block mean, |
| | | with real numeric |
| | | data type |
| Nearest_block_std | Real | The most recent received |
| | | data block standard |
| | | deviation value, has a |
| | | real numeric data type |

Step 2: make a selection number of blocks and number of points in one block, divide the historical data into equal sized blocks and build formulas to calculate the mean, standard deviation of each data block and the whole data:

From the starting idea of dividing historical data into smaller blocks to facilitate real time anomaly detection calculations, the calculation of the mean, the standard deviation is done as follows: with the mean, the average of n×m data points is equal to the average of the arithmetic mean of m blocks, where each block has n data points; with standard deviation, averaging the standard deviation of m blocks, where each block has n data points, will calculate that block standard deviation. Specifically, the method of dividing data blocks and calculating the average, standard deviation of each block and the whole data includes the following steps:

Step 2.1: Divide historical data into equal blocks: assuming the historical data to be averaged is n×m data points, we divide it into m data blocks, each containing n data points. The choice of two parameters n and m depends on the characteristics of each different data type, based on the requirement between the data processing speed and the data average used to detect the outlier data. For example, when we divide more blocks (m large) and each block has a large number of points (n large), the data processing speed will be slower, and the comparison of new incoming data with the data average will be less accurate.

Step 2.2: determine the historical data points to use, these points are past data from the present time, assuming those points denoted by

a₁₁, a₂₁, . . . , aₙ₁, a₁₂, a₂₂, . . . , aₙ₂ . . . , a₁ₘ, a₂ₘ, . . . , aₙₘ are the first data point, the second data point, . . . , the n×m data point respectively.

Step 2.3: The mean (denoted by mean) is calculated by adding all the data points and dividing the result by the number of data points, and the median standard deviation (denoted by median_std) is calculated as the median of the standard deviations of the smaller blocks, respectively. Here is the formula:

$$mean = \frac{{a}_{11} + {a}_{21} + … + {a}_{nm}}{n \times m} = \frac{\begin{matrix}\frac{{a}_{11} + {a}_{21} + … + {a}_{n 1}}{n} + \frac{{a}_{12} + {a}_{22} + … + {a}_{n 2}}{n} + \\ … + \frac{{a}_{1 m} + {a}_{2 m} + … + {a}_{n m}}{n}\end{matrix}}{m} = \frac{mean\_block \_ 1 + mean\_block \_ 2 + … + mean\_block \_m}{m}$$

$$median\_std = median ( std\_block \_ 1 , std\_block \_ 2 , … , std\_block \_m )$$

In which, the standard deviation of each block (denoted by std_block_i) is calculated according to the following formula:

$$std\_block \_i = \sqrt{\frac{{\sum }_{k = 1}^{n} {\vert {a}_{ki} - mean\_block \_i \vert}^{2}}{n - 1}}$$

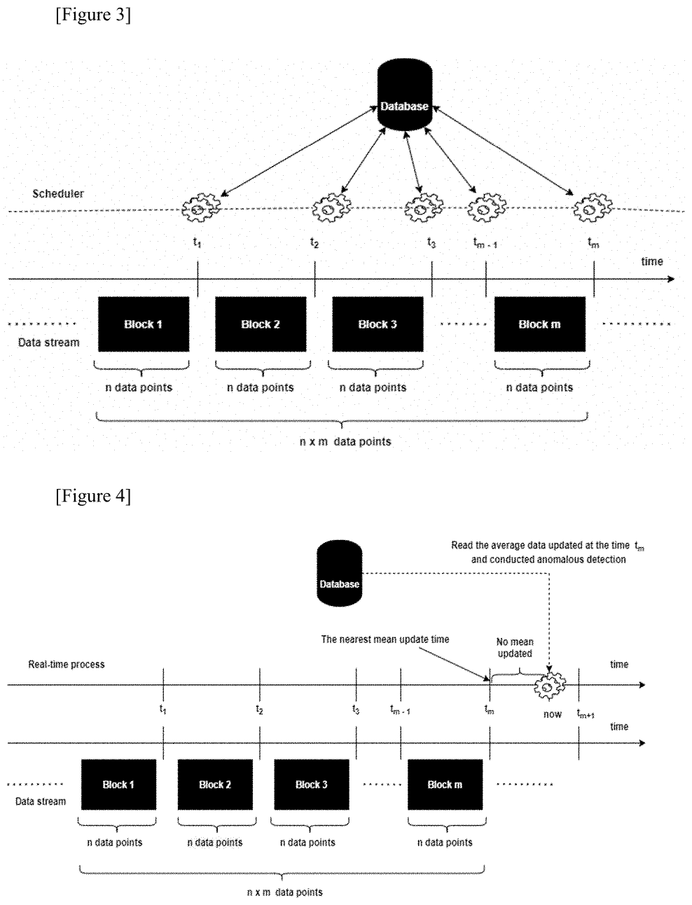

Refer to FIG. 3, which depicts the breakdown of historical data into smaller blocks to handle the arithmetic mean, standard deviation per block, and the mean, median standard deviation over the entire data set.

Step 3: Data mapping process (called Process Mapping Data) runs independently to read the collected data. Because the data collected by the agents is often in a raw form (usually in json format—javascript object notation) including many different fields, we need to separate the data into the required fields for anomaly detection and normalization of data to real number format. Post-normalized data is written to the in-memory database by the process over time. The data in the database has a data structure like Table 1.

Step 4: Perform anomaly detection of incoming data with the mean, the median standard deviation of historical data already stored in the database on read-only memory (RAM).

To perform anomaly detection according to the data division in step 2. We use two independent processes: The process of calculating the mean, the standard deviation, performing the calculation when n points have been collected data for that block and for all historical data is shown in step 4.1; Anomalous data detection real time process reads the data in real time and checks whether the data point is anomalous performed in step 4.2. As follows:

Step 4.1: process the calculation of the mean, the standard deviation of the data blocks, the mean, the median standard deviation of the whole data and save it in the database for the mean, the standard deviation values with the data structure as Table 2, and are stored directly on RAM:

The process of calculating the mean, standard deviation is scheduled to execute after n×t time because the data is written to the database in t time period, so after n×t time we proceed the next steps.

Step 4.1.1: read historical data for the last n points in the database stored in step 3.

Step 4.1.2: calculate the mean and standard deviation of the n points obtained.

Step 4.1.3: calculate the mean of all historical data blocks stored on the database: based on the mean, standard deviations of up to m−1 previously calculated data blocks, and the mean, standard deviation of the nearest n points, we can calculate the mean and the median standard deviation of all historical data using the formulas established in step 2.3.

Step 4.1.4: save the last n point mean, the nearest n point standard deviation, the mean of all historical data, and the median standard deviation of all historical data into a structured database Table 2 to query.

Step 4.2: anomaly real time process reads real time data from the database and performs anomaly detection:

Existing data will be checked for anomalous condition by parametric method based on statistics, namely algorithm based on mean and historical data standard deviation as follows:

Let x_{current} be the current value of the data obtained, mean and median_std are mean, median standard deviation of the most recent historical data from the current data point calculated in step 4.1.3, respectively. Then:
x_{current} is anomalous if
x_{current}<mean−factor×median_std
or x_{current}>mean+factor×median_std

In which, factor will be determined by the empirical rule, usually taken as 3.

If x_{current} is an abnormal data point, it will be saved in the database and sent directly to the alarm system so that the operator of the network system will check and correct the error.

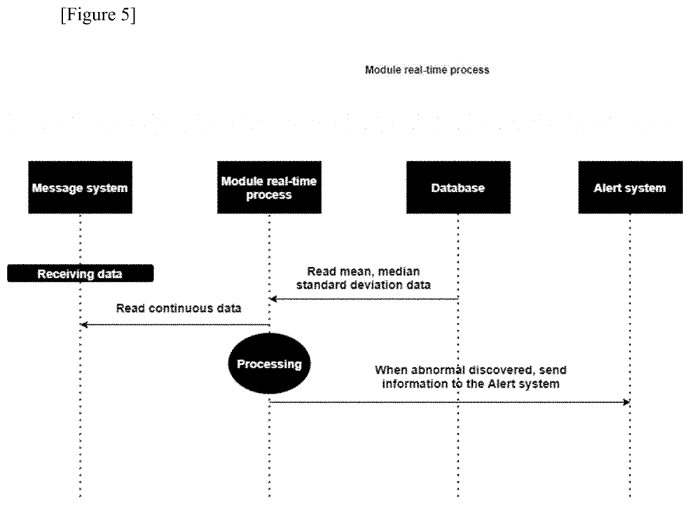

Refer to FIG. 4, which describes the real time process of detecting anomalous data at a specific time, and FIG. 5, which describes the real time data processing flow of the anomaly detection system. When new data arrives at the anomaly detection system, the real time processor process will perform a mean, median standard deviation read of the historical data from the in-memory database (in-memory database), then compare the newly arrived data with the average of that historical data and finally make a conclusion whether the data point is abnormal or not, if so, issue a warning to the system warning.

### EFFECTIVENESS OF THE INVENTION

Solve the problem of real time anomaly detection, anomaly response time<1 minute (from anomaly appearance time to giving warning).

Save on storage costs on RAM and don't have to scan the hard drive repeatedly.

What is claimed is:

1. Method of processing and storing data of real time anomaly detection problem with specific steps as follows:
step 1: build a historical in-memory database over time, a database of mean and standard deviation;
step 2: make a selection number of blocks and number of points in one block, divide the historical data into equal sized blocks and build a formula to calculate a mean, standard deviation of each data block and the mean, the median standard deviation of the whole data;
step 2.1: divide historical data into equal blocks;
step 2.2: determine the historical data points to use;
step 2.3: construct formulas to calculate the mean, the standard deviation of data blocks and the mean, the median standard deviation of the whole data;
step 3: create an independently running data mapping process that reads collected data, normalizes the data, and interacts with the in-memory database to write historical data according to time;
step 4: perform data anomaly detection of incoming data with the mean, median standard deviation of historical data already stored in the in-memory database on read-only memory (RAM); using two independent processes: the mean, standard deviation calculation process when n data points have been collected for that block and for all historical data shown in step 4.1; real time process that detects anomaly data reads data in real time and checks whether the data point is anomalous doing in step 4.2;
step 4.1: process the calculation of the mean, the standard deviation of the last data blocks and the mean, the median standard deviation of the whole data, and save it in the in-memory database for the mean, the standard deviation value with the data structure as shown in the table below

| Field name | Datatype | Meaning |
|---|---|---|
| Id | Integer | Table primary key, |
| | | integer data type, unique |
| | | identifier |
| Timestamp | Milliseconds | Historical mean data |
| | | logging time, with time |
| | | data type |
| Mean | Real | Mean of all necessary |
| | | historical data, with real |
| | | number data type |
| Median_standard_deviation | Real | Median of block standard |
| | | deviations of all |
| | | historical data, |
| | | with data type real |
| Nearest_block_mean | Real | Last received data block |
| | | mean, with real numeric |
| | | data type |
| Nearest_block_std | Real | The most recent received |
| | | data block standard |
| | | deviation value, has a |
| | | real numeric data type, |

and are store directly on RAM;
step 4.1.1: read historical data for the last n points in the database stored in step 3;
step 4.1.2: calculate the mean and standard deviation of the n points obtained;
step 4.1.3: calculate the mean of all historical data blocks stored on the database;
step 4.1.4: save the last n point mean, the nearest n point standard deviation, the mean of all historical data, and the median standard deviation of all historical data into a structured database Table 2 to query; and
step 4.2: real time anomaly detection process reads real time data from the in-memory database and performs anomaly detection.

2. The method of processing and storing data for real time anomaly detection problem according to claim 1, in which:
at step 1, build a historical in-memory database over time, a database of mean and standard deviation, the structure of the in-memory database is in the form of tables as follows:
TABLE 1
Historical data table over time

| Field name | Datatype | Meaning |
|---|---|---|
| Id | Integer | Table primary key, integer |
| | | data type, unique identifier |
| | | of the data |
| Timestamp | Milliseconds | The time the data was |
| | | written, has the time data |
| | | type |
| Source | String | Data information to be |
| | | written, has a string data |
| | | type |
| Value | Real | Received data value, has |
| | | real numeric data type |

TABLE 2
Table of mean and standard deviation.

| Field name | Datatype | Meaning |
|---|---|---|
| Id | Integer | Table primary key, |
| | | integer data type, unique |
| | | identifier |
| Timestamp | Milliseconds | Historical mean data |
| | | logging time, with time |
| | | data type |
| Mean | Real | Mean of all necessary |
| | | historical data, with real |
| | | number data type |
| Median_standard_deviation | Real | Median of block standard |
| | | deviations of all |
| | | historical data, with data |
| | | type real |
| Nearest_block_mean | Real | Last received data block |
| | | mean, with real numeric |
| | | data type |
| Nearest_block_std | Real | The most recent received |
| | | data block standard |
| | | deviation value, has a |
| | | real numeric data type |

3. The method of processing and storing data for real time anomaly detection problem according to claim 1, in which:
at step 2, divide historical data into equal blocks, namely: suppose historical data to be mean, standard deviation is n×m data points, divide into m data blocks, each block contains n points data, Then determine the number of historical data points to use.

4. The method of processing and storing data for real time anomaly detection problem according to claim 1, in which:
at step 2, build formulas to calculate mean, standard deviation of block data and mean, median standard deviation of whole data.

5. The method of processing and storing data for real time anomaly detection problem according to claim 1, in which:
at step 3, the independently running data mapping process remove null data, standardize data suitable data type in a Table 1 below as:
TABLE 1
Historical data table over time.

| Field name | Datatype | Meaning |
|---|---|---|
| Id | Integer | Table primary key, integer |
| | | data type, unique identifier |
| | | of the data |
| Timestamp | Milliseconds | The time the data was |
| | | written, has the time data |
| | | type |
| Source | String | Data information to be |
| | | written, has a string data |
| | | type |
| Value | Real | Received data value, has |
| | | real numeric data type |

6. The method of processing and storing data for real time anomaly detection problem according to claim 1, in which:
at step 4, this step using two independent processes: the mean, standard deviation calculation process; the real time anomaly detection process that detects anomaly data.

7. The method of processing and storing data for real time anomaly detection problem according to claim 1, in which:
at step 4, the mean, standard deviation calculation process is scheduled to execute after n×t time because the data is written to the database in t time period.

8. The method of processing and storing data for real time anomaly detection according to claim 1, in which:
at step 4, in process to calculate the mean, standard deviation problem contains the first small step: read historical data for the last n points in the database stored in Step 3.

9. The method of processing and storing data for real time anomaly detection problem according to claim 1, in which:
at step 4, in process to calculate the mean, standard deviation contains the second small step: calculate the mean and standard deviation of the n points obtained.

10. The method of processing and storing data for real time anomaly detection problem according to claim 1, in which:
at step 4, in process to calculate the mean, standard deviation contains the third sub-step: calculate the mean, the median standard deviation of all historical data blocks stored on the database: based on the mean, standard deviations of up to m−1 previously calculated data blocks, and the mean, standard deviation of the nearest n points, The mean and the median standard deviation of all historical data using the formulas established in step 2.3.

11. The method of processing and storing data for real time anomaly detection problem according to claim 1, in which:
at step 4, in process to calculate the mean, standard deviation contains four sub-steps: save the last n point mean, the nearest n point standard deviation, the mean of all historical data, and the median standard deviation of all historical data into the above table data structured database to query.

12. The method of processing and storing data for real time anomaly detection problem according to claim 1, in which:
at step 4, in real time anomaly detection process, build a formula for detecting anomalous data.
